(19) United States
(12) Patent Application Publication
(10) Pub. No.: US 2008/0206433 A1
(43) Pub. Date: Aug. 28, 2008

(54) Packaged soy beverage with carbonation

(76) Inventor: Al Kushner, Royersford, PA (US)

Correspondence Address: FURR LAW FIRM, 2622 DEBOLT ROAD, UTICA, OH, 43080, US

(21) Appl. No.: 11/678,007

(22) Filed: Feb. 22, 2007

(51) Int. Cl. A23L 2/38

(52) U.S. Cl. 426/598

(57) ABSTRACT

The invention relates to a carbonated soy beverage which has been packaged under pressure in a pressure-resistant closed container, which beverage is based on soy extract, the soy beverage having been packaged in the closed container in the presence of CO₂ and nitrogen, which beverage preferably contains sugar and/or sweetener.

### BACKGROUND

The invention relates to a carbonated soy beverage which has been packaged under pressure in a pressure-resistant closed container.

Soyfoods are rapidly becoming a part of many American's healthy diets. Soybeans have been identified as a food source that has health benefits. In October of 1999, the Food and Drug Administration reported that 25 grams of soy protein daily as part of a diet low in saturated fat and cholesterol may reduce the risk of heart disease. The New England Journal of Medicine published a study in 1995 that concluded a diet with soy protein reduced serum cholesterol in people with moderately high to high cholesterol. In addition, this report indicated that the inclusion of soy protein in the diet lowered the LDL or “bad” cholesterol but not the HDL or “good” cholesterol. It is especially suitable for individuals who are suffer from conditions making them caffeine intolerant, e.g., pregnancy, or those who suffer from hypoglycemia, hypertension, arrhythmia, insomnia, or gastric irritation. Other features and advantages of the coffee substitute will become more apparent with the accompanying method, which illustrates, by the way of example, the principle of the invention.

Carbonated soft drinks packaged under pressure in cans are produced and sold on a large scale. The greater part of this market consists of beverages such as colas, soft drinks, lemonades with a fruit flavor and the like. There is also a clear interest in cooled tea, optionally slightly carbonated and/or provided with a supplementary fruit flavor and/or sweetened.

### SUMMARY OF THE INVENTION

The object of the invention is to provide a type of packaged soy drink (soy extract), which improvement relates especially to the taste, and to a lesser extent to the foaming.

The quality and especially the taste of the carbonated soy beverage which has been packaged under pressure in a pressure-resistant container, which beverage is based on soy extract, with the soy beverage having been packaged in the closed container, can be improved by the presence of nitrogen in the package.

Accordingly, the invention relates to a carbonated soy beverage which has been packaged under pressure in a pressure-resistant closed container, which beverage is based on soy extract, the soy beverage having been packaged in the closed container in the presence of CO₂ and nitrogen.

The improvement of the taste is particularly surprising, since it was not known that the presence of nitrogen, known to be a highly inert gas, might have any influence on the taste. It has been found that the taste of the soy becomes creamier and less sharp, while this taste at the same time becomes richer in character.

### BRIEF DESCRIPTION OF DRAWINGS

Without restricting the full scope of this invention, the preferred form of this invention is illustrated in the following drawings:

FIG. 1 shows a can of carbonated soy beverage.

### PREFERRED EMBODIMENT

According to the invention, the beverage consists of soy extract (soy), optionally supplemented with conventional additions, such as sugar, sweeteners, nutrient acid and the like. It is also possible to add supplementary flavor components to the beverage, such as cinnamon, cocoa, rum flavor, fruit flavors and the like.

The soy extracts to be used can have been obtained in a known manner by extraction of roasted soy, and supplemented with water to the desired strength. If desired, one can also start from a wholly or partly soy

Optionally, the beverage can also be supplemented with an amount of alcoholic beverage, such as rum, whisky, and the like. It is possible to add milk or milk products to the beverage. If desired, it is also possible to add so-called whiteners, which are not based on milk.

According to a preferred embodiment of the invention, the contents of the container consist substantially of soy extract, water, CO₂, nitrogen, optionally in combination with aromatic, flavoring and sweetening substances.

The mutual proportions of the various components of the soy beverage can be chosen fairly broadly, the eventual composition being partly dependent on the desired taste of the soy drink. The amount of gas in the container (carbon dioxide and nitrogen) is chosen such that the pressure in the package is minimally at the level required for the strength of the package. A conventional pressure at room temperature is between 1.01 and 7.0 bar. In case pasteurization is to take place, the maximum pressure is preferably not higher than 3.0 bar. In this connection, it is noted that in the thin cans currently used, an internal pressure is necessary to impart the desired strength to the cans.

According to the invention, such an amount of nitrogen is added that the pressure at 20.degree. C. is 0.2 to 2.0 bar higher than the pressure existing as a result of the addition of CO₂ and which can vary from 0.5 to 5.0 bar.

The invention is specifically directed to foaming or effervescent (fizzy, sparkling) soy, which means that the content of CO₂ dissolved in the liquid is greater than 0.15% by weight, more particularly greater than 0.25% by weight (based on the weight of CO.sub.2 with respect to the total weight of the liquid).

In practice, it has been found that it is not easy to determine the proper dosage of nitrogen.

In a number of types of soy extract, an (unpredictable) excessive foaming can occur. It has been found that a good and predictable foaming behavior is obtained by adding from 0.5 to 10 ppm foam inhibiting agent, typically based on polysiloxanes, such as dimethyl siloxane.

It has additionally been found that another advantage of the invention resides in the fact that the use of nitrogen in the pressurized package gives an improvement of the structure of the foam layer. The consumer sometimes prefers that with ice soy, after it has been poured out, a foam layer is present on the soy. It is true that the presence of carbon dioxide in the package already gives rise to some foaming, but the amount and the structure of the foam are not satisfactory if carbon dioxide alone is used. By the co-use of nitrogen, the amount and the nature of the foam have been found to have clearly improved. In this connection, it is noted that it is known that nitrogen can effect an improvement of the foam structure in carbonated beverages.

For the purpose of packaging the beverage in the package, the conventional packaging techniques can be used, provided that it is ensured that the desired amounts of nitrogen gas and carbon dioxide gas are introduced into the package. This is preferably done immediately before the package is closed, prior to pasteurization. The addition can occur in the form of solid carbon dioxide or liquid nitrogen, but it is also possible to introduce the components into the package in gaseous form under pressure. This last can be done in the form of separate gases or by first mixing the gases in the proper amounts and dosing the mixture under pressure.

The invention will now be further explained in and by some examples, which should not be construed as a limitation of the invention.

The beverage of the present invention lacks caffeine and has a nutritional profile better than that of coffee. The product of the present invention also has a higher protein content. Further, the beverage of the present invention does not deteriorate upon reheating. Therefore, not only does the product of the present invention appeal to consumers interested in health foods and concerned about caffeine, but it appeals to regular coffee drinkers as well.

The improvement of the taste is particularly surprising, since it was not known that the presence of nitrogen, known to be a highly inert gas, might have any influence on the taste. It has been found that the taste of the soy becomes creamier and less sharp, while this taste at the same time becomes richer in character.

### EXAMPLE 1

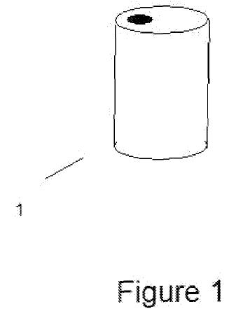

A standard aluminum can 1, as shown in FIG. 1, of a contents of 0.33 l was filled with an amount of soy extract and supplemented with water to the desired strength. Also, an amount of sugar has been added to the contents. Prior to pasteurizing at 62.degree. C., so much carbon dioxide and so much nitrogen were dosed to the contents that these gases, upon cooling, respectively provided a partial pressure of 1.75 and 1.25 bar in the can, with a total pressure of 3.0 bar. The content of dissolved carbon dioxide was 0.35% by weight.

Upon cooling of the can with its contents to a temperature of 4-6.degree. C. (refrigerator temperature), the contents were poured out in a cup. A fine foam layer on the surface was observed, of a structure comparable to espresso, which foam layer endured for a prolonged period of time, while the taste of the soy was excellent.

### COMPARATIVE EXAMPLE

For comparison, a can with the same components was fabricated, except that the nitrogen had been omitted. Upon cooling to refrigerator temperature, the contents were likewise poured out in a cup. In comparison with the previous test, the taste was clearly poorer, that is, a less rich, sharper taste, which moreover was less creamy. The foam layer was highly irregular and endured only for a short time.

### EXAMPLE 2

Example 1 was repeated, but in addition to the soy extract a soy extract with caffeine was used. As sweetener, a conventional sweetener was used, such as evaporated cane juice, stevia, and/or splenda.

Thus, a calorie-free soy beverage was obtained, which, consumed cool, represented excellent ice soy, comparable in quality with the soy of Example 1.

We claim:

1. A packaged carbonated soy beverage with at least one of improved taste and foaming behavior, consisting essentially of:
a soy beverage, CO₂ and nitrogen gas in a pressure-resistant closed container;
wherein the CO₂ is dissolved in the soy beverage in an amount greater than 0.15 wt. % and the pressure in the closed container due to the CO₂ is from 0.5 to 5.0 bar;
wherein the nitrogen gas is present in an amount corresponding to a pressure in the closed container at 20.degree. C. of 0.2 to 2.0 bar higher than the pressure due to the CO₂ addition; and
wherein the total pressure in the closed container is from 1.01 to 7.0 bar.

2. A carbonated beverage according to claim 1, further comprising at least one of sugar and sweetener.

3. A carbonated beverage according to claim 1, further comprising aromatizing, flavoring, and sweetening substances.

4. A carbonated beverage according to claim 1, wherein the container has been made of metal.

5. A carbonated beverage according to claim 1, wherein also 0.5 to 10 ppm of foam inhibiting agent is present.

6. A packaged carbonated beverage according to claim 1, wherein CO₂ is dissolved in the soy beverage in an amount greater than 0.25 wt. %.

7. A packaged carbonated beverage according to claim 1, wherein CO₂ is dissolved in the soy beverage in an amount of 0.35 wt. %.

8. A packaged carbonated beverage according to claim 1, further comprising at least one of water and milk.

9. A packaged carbonated beverage according to claim 1, wherein said nitrogen causes the soy beverage to become less sharp
